(19) United States
(12) Patent Application Publication
(10) Pub. No.: US 2010/0039216 A1
(43) Pub. Date: Feb. 18, 2010

(54) Crash detection system and method

(76) Inventors: Lee Knight, San Diego, CA (US); John Tomljenovic, Los Angeles, CA (US)

Correspondence Address: Ralph C. Francis, Esq.;Francis Law Group, 1942 Embarcadero, Oakland, CA, 94606, US

(21) Appl. No.: 12/583,651

(22) Filed: Aug. 25, 2009

Related U.S. Application Data
(63) Continuation of application No. PCT/US2005/018150, filed on May 20, 2005.

(51) Int. Cl. G05B 19/00; G01S 19/16

(52) U.S. Cl. 340/5.1; 342/357.07

(57) ABSTRACT

A system (10) and apparatus (32) for detecting unauthorized or unsafe movement or crash detection of a moveable object (30) where the system includes a GPS receiver (32), cellular modulator (32), processor (32), pager modem (32), sensor (32) and two-way pager (34). When the system (32) is coupled to a moveable object (30) and is armed via the pager, the sensor is monitored by the processor to determine when a possible theft of the moveable object may be occurring. When the system is coupled to a moveable object and is not armed, the sensor is monitored by the processor to determine when a possible crash detection of the moveable object may be occurring or occurred.

### CROSS-REFERENCE TO RELATED APPLICATIONS

This application is a continuation of International Application No. PCT/US2005/018150, filed May 20, 2005, which claims the benefit of U.S. application Ser. No. 10/850,624, filed May 21, 2004.

### FIELD OF THE PRESENT INVENTION

The present invention relates to methods and apparatus for preventing theft and crash detection of movable objects, and more particularly, to methods and systems for crash detection of motorized vehicles.

### BACKGROUND OF THE INVENTION

Anti-theft and crash detection systems for movable objects ideally track the movable object when a theft or crash has occurred. Traceable or position determinable anti-theft and crash detection systems are commonly large and expensive. It is desirable to have a traceable or position determinable anti-theft or crash detection system that is small, concealable, and inexpensive. For example, a motorcycle may be easily stolen or involved in a crash, but present traceable or position determinable anti-theft or crash detection systems are neither concealable nor effective for such a moveable object.

A need thus exists for a small, concealable, and inexpensive traceable and position determinable crash detection system and associated method.

### SUMMARY OF THE INVENTION

The present invention includes a small, concealable, inexpensive traceable and position determinable anti-theft or crash detection system and method. The method and system includes a GPS receiver, cellular modulator, processor, pager modem, sensor and two-way pager. When the system is coupled to a moveable object and is armed via the pager, the sensor is monitored by the processor to determine when a possible theft of the moveable object may be occurring. When the system is coupled to a moveable object and is not armed via the pager, the sensor is monitored by the processor to determine when a possible crash of the moveable object may be occurring or occurred.

In one embodiment of the invention, the sensor is a multiple axis accelerometer. In one embodiment, the accelerometer is a two axes accelerometer where the sensor detects small movements of the object in two axes. In another embodiment, the accelerometer is a three axis accelerometer where the sensor detects small movements of the object in three axes.

According to the invention, when the sensor is triggered while armed, the processor pages the two-way pager. The processor also determines the system's location via the GPS receiver.

In one embodiment, the processor generates a message including the system's location and unique system identifier. The processor transmits the message to a monitoring center via a cellular network (and the cellular modulator). In one embodiment, the message comprises a text message that is transmitted using a GSM, GPRS, or Short Messaging Service cellular based network.

When the sensor is triggered while the system is not armed, the processor via a library of acceleration or motion data, can determine whether a crash has occurred. According to the invention, the processor can also determine the system's location via the GPS receiver.

In one embodiment of the invention, the crash detection system and method determines that a crash has occurred when the acceleration data indicates that the motor vehicle has spun in a circle. In another embodiment, the crash detection system and method determines a crash has occurred when the acceleration data indicates that the motor vehicle has rolled, tipped over in the case of a car and laid on its side in the case of a motorcycle.

In the event of the noted crash parameters, the processor is adapted to generate a message, including the system's (and, hence, vehicle) location and unique system identifier. The processor can transmit the message to a monitoring center via a cellular network (and the cellular modulator). In one embodiment, the message similarly comprises a text message that is transmitted using a GSM, GPRS, or Short Messaging Service cellular based network.

According to the invention, the monitoring center can automatically perform a number of tasks upon receipt of such a crash message. The center can log the time and date receipt and forward the tracking information to an appropriate organization, such as an ambulance center, police, or likes' computer or office. The monitoring center can also contact a designated contact (such as the object's owner or custodian) via a pager, or series of telephone numbers, email, or other electronic means.

The GPS antenna is ideally a small omni directional antenna that may be hidden in the moveable object. The cellular antenna is also ideally a small omni directional antenna that may be hidden in the moveable object. For example, when the moveable object is a motorcycle, the GPS and cellular antenna can be mounted in a holding apparatus. According to the invention, the holding apparatus can be mounted directly on the frame or handle bars of motorcycle. The apparatus can also be mounted in concealed locations, such as on the fairing, fenders, seats, or saddlebags. The omni directional nature of each antenna permits them to operate (receive/transmit signals) in these locations.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a schematic illustration of anti-theft and crash detection system architecture, in accordance with one embodiment of the invention;

FIG. 2 is a block diagram of a monitoring center system, in accordance with one embodiment of the invention;

FIG. 3 is an illustration of one application of the anti-theft and crash detection system, in accordance with one embodiment of the invention;

FIG. 4 is a block diagram of an anti-theft and crash detection system, and associated two-way pager, in accordance with one embodiment of the invention;

FIG. 5 is a flow chart illustrating an anti-theft and crash detection system algorithm, in accordance with one embodiment of the invention;

FIG. 6 is a flow chart illustrating an initial acceleration processing algorithm, in accordance with one embodiment of the invention;

FIG. 7 is a flow chart illustrating a crash detection algorithm, in accordance with one embodiment of the invention;

FIG. 8 is a flow chart illustrating an algorithm for populating a crash data library, in accordance with one embodiment of the invention;

FIG. 9 is a block diagram of a three axis accelerometer, in accordance with one embodiment of the invention;

FIG. 10 is a flow chart illustrating an algorithm for orienting a sensor, in accordance with one embodiment of the invention;

FIG. 11 is a flow chart illustrating an algorithm for determining crash severity, in accordance with one embodiment of the invention; and

FIG. 12 is a flow chart illustrating an algorithm for determining when to dispatch emergency services a crash site, in accordance with one embodiment of the invention.

### DETAILED DESCRIPTION

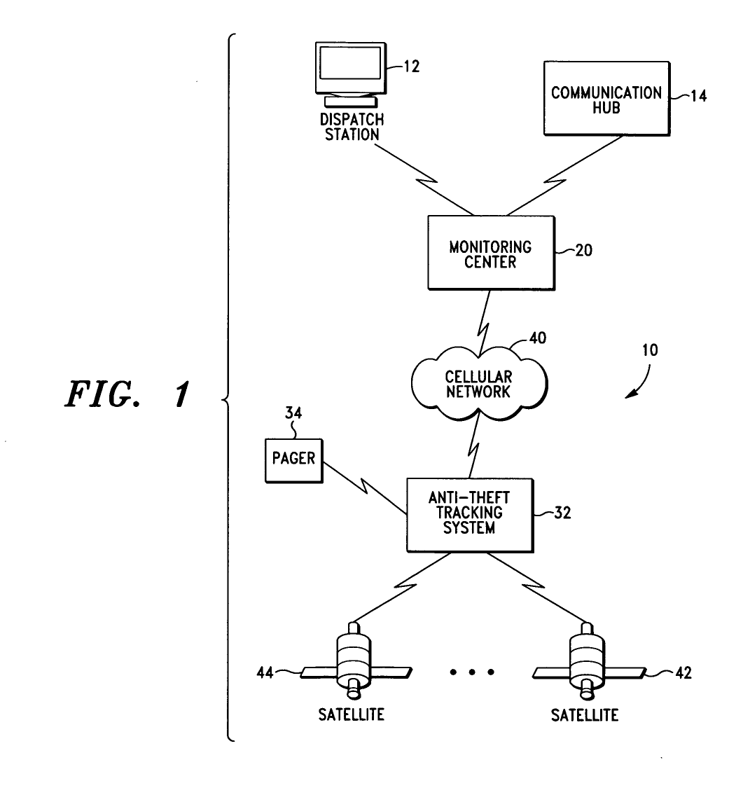

Referring first to FIG. 1, there is shown an illustration of one embodiment of anti-theft and crash detection system architecture 10 of the present invention. As illustrated in FIG. 1, the system 10 includes an anti-theft and crash detection system (“ATS”) 32 (which is adapted to be mounted on a moveable object), pager 34, GPS satellites network 42, 44, cellular network 40, monitoring center 20, dispatch station 12, and communication hub 14. Each of the noted subsystems is described in detail below

The anti-theft and crash detection system architecture 10 and the noted subsystems thereof are also described in detail in Co-Pending application Ser. No. 10/850,624; which is expressly incorporated by reference herein in its entirety.

According to the invention, the dispatch station 12 can be operated by a police department. When the system 32 generates a theft or crash detection message (including a location and identifier), the monitoring center can forward this information to the dispatch station 12 and/or communication center 14. The communication hub 14 is adapted to alert the owner or custodian of the object that a theft may be occurring. The monitoring center 20 can be completely automated or may have one or more human operators that help process and forward theft or crash detection messages to the appropriate individuals or organizations.

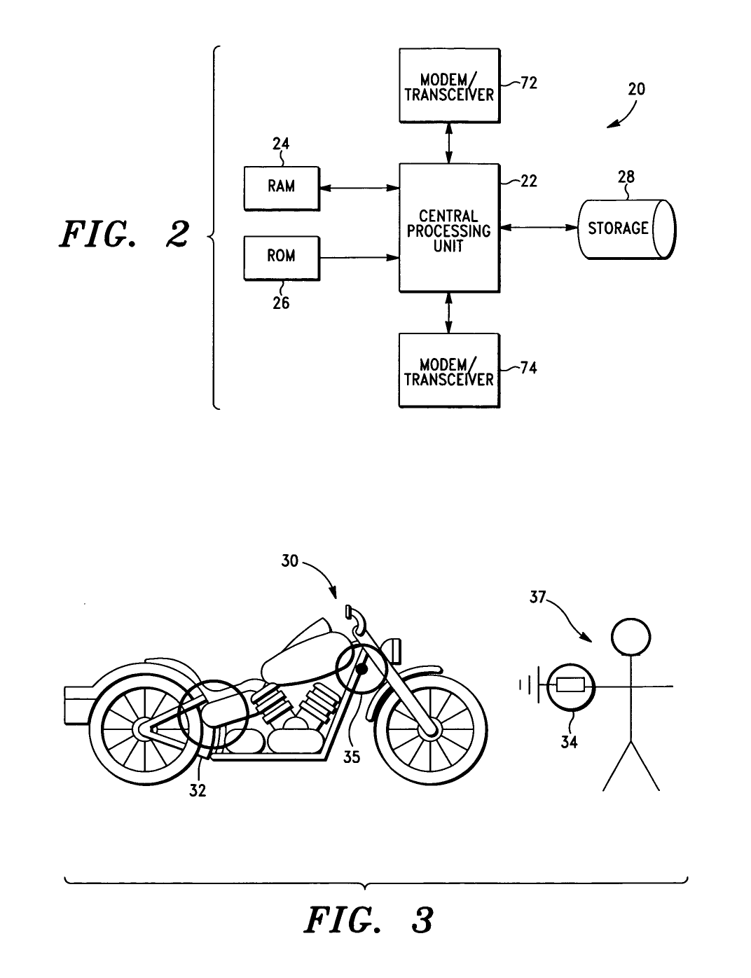

Referring now to FIG. 2, there is shown a block diagram of one embodiment of a monitoring center system (“MCS”) 20 of the present invention. The MCS 20 preferably includes a CPU 22, RAM 24, ROM 26, storage unit 28, a first modem/transceiver 72 and a second modem/transceiver 74.

As illustrated in FIG. 2, the first modem/transceiver 72 couples the NMC 20 to the dispatch station 12 and communication hub 14. In one embodiment, the modem/transceiver 72 comprises an Ethernet modem connecting the MCS to a local network or Internet. The second modem/transceiver 74 couples the MCS 20 the cellular network 40. The modem/transceiver can again be an Ethernet modem, telephone modem, wireless modem or other communication device that is adapted to communicate with the cellular network 40.

The CPU 22 directs communications between the first and second modem 72, 74 for messages between the dispatch terminals 12 and 14 and one or more anti-theft tracking and crash detection systems 32. According to the invention, the MCS 20 can handle messages from numerous anti-theft tracking and crash detection systems 32 at various geographical locations and can forward the message(s) to different dispatch stations as a function of the indicated location of a respective one or multiple systems 32 (as noted in the received message). The MCS 20 is also preferably adapted to log received messages in the storage 28.

In a preferred embodiment, the ROM 26 is adapted to store program instructions to be executed by the CPU 22. The RAM 24 can also be used to store temporary program information.

Referring now to FIG. 3, there is shown an illustration of one application of an ATS 32, in accordance with one embodiment of the invention. In the illustrated application, the ATS 32 is mounted on a motorcycle 30. The ATS 32 is ideally mounted in a concealed location, such as under the seat.

In one embodiment, the ATS 32 is coupled to the motorcycle's battery. In another embodiment, the ATS 32 has its own battery that operates when the motorcycle's battery signal is insufficient.

In the illustrated application shown in FIG. 3, the GPS antenna and cellular antenna 35 are mounted on the motorcycle frame. According to the invention, a user 37 can arm the ATS 32 via a two-way pager 34. The ATS 32 can also signal the user 37 via the pager 34 when a sensor triggering occurs (potential theft or crash detection).

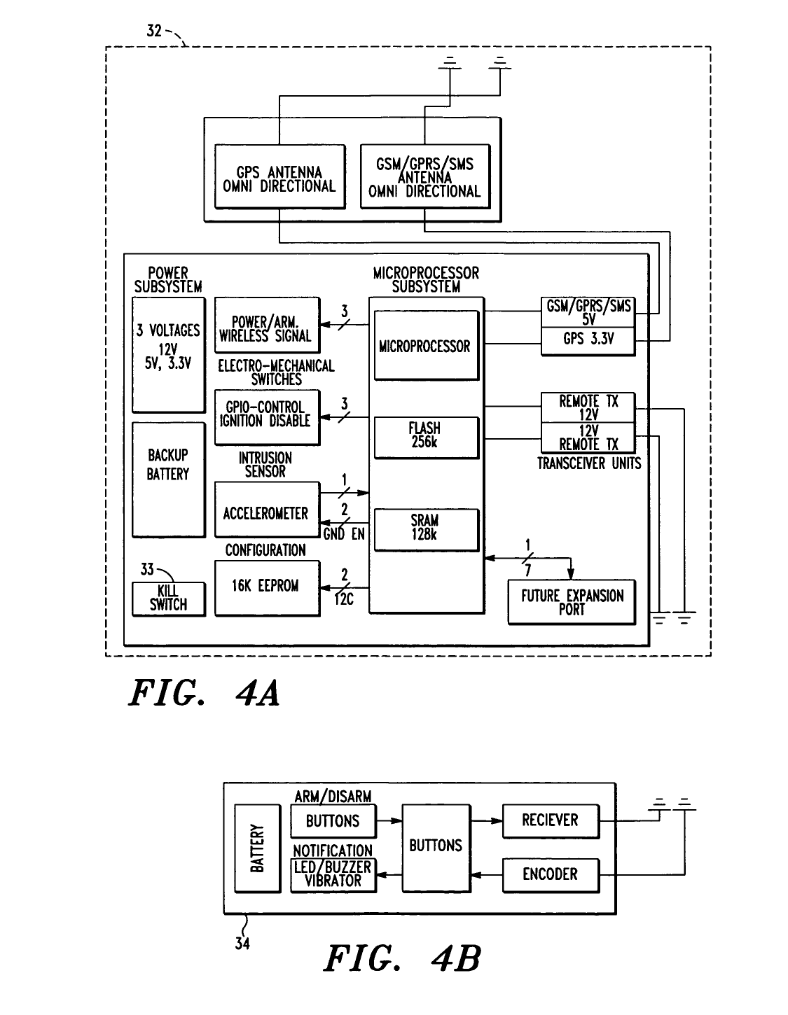

Referring now to FIG. 4, there is shown a block diagram of an ATS 32 and associated two-way pager, in accordance with one embodiment of the invention. FIG. 4 details specific components that can be employed in an ATS 32, which include an accelerometer (or motion sensor), GPS and GSM/GPRS/SMS Antennas and a main board, and pager 34, in accordance with one embodiment of the present invention.

In the illustrated embodiment of the invention, the sensor includes a multiple axis accelerometer. The sensor can also detect movement by comparing GPS positions when armed and generating an alarm signal when the GPS position indicates a change in position.

In the illustrated embodiment, the ATS 32 further includes a kill switch component 33 that is coupled to the main controller of the device. The kill switch component 33 is designed and adapted to direct the device main controller to shut down the engine or other components to disable the vehicle.

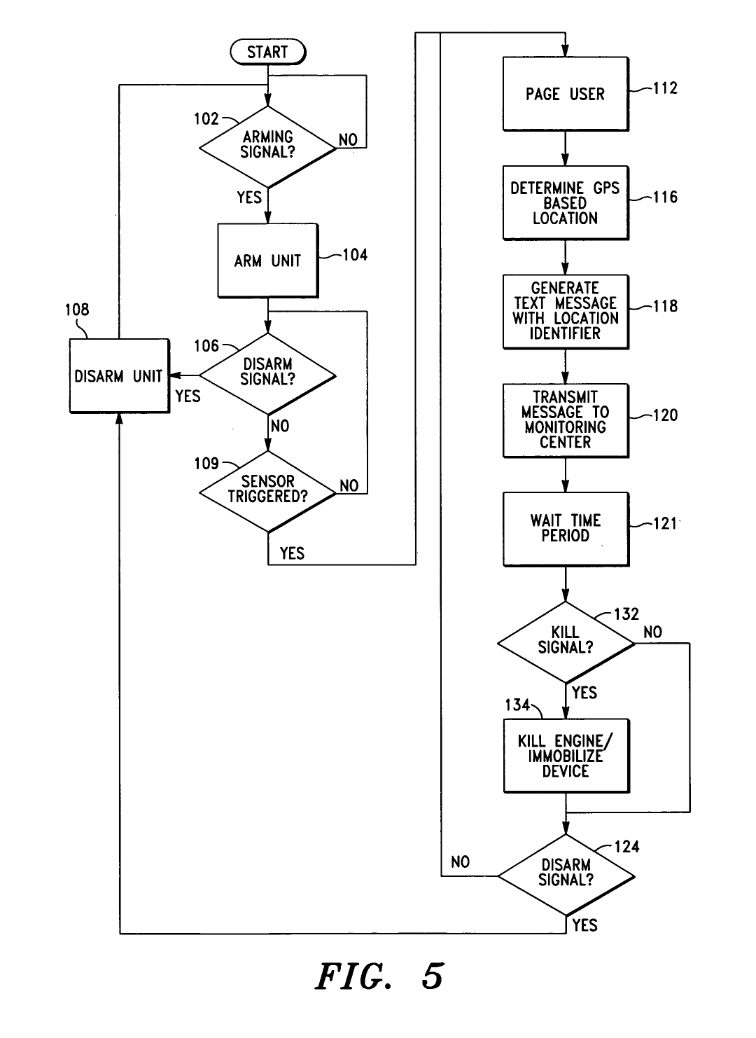

Referring now to FIG. 5, there is shown an illustration of an ATS algorithm 100, in accordance with one embodiment of the present invention. As shown in FIG. 5, when the ATS 32 is armed, the ATS 32 determines when a sensor is triggered (steps 102-109). When the sensor is triggered, the ATS 32 pages a user via the pager (step 112), determines the location of the ATS via a GPS system (step 116), generates a message including the location and a unique identifier for the ATS 32 (step 118), and transmits the message to a monitoring center (step 120). The ATS repeats steps 112-120 periodically until the ATS 32 is disarmed (steps 121 and 124). In an exemplary embodiment, the process 100 directs the device to kill an engine or otherwise immobilize the device (step 134) when a kill signal is received/detected (step 132).

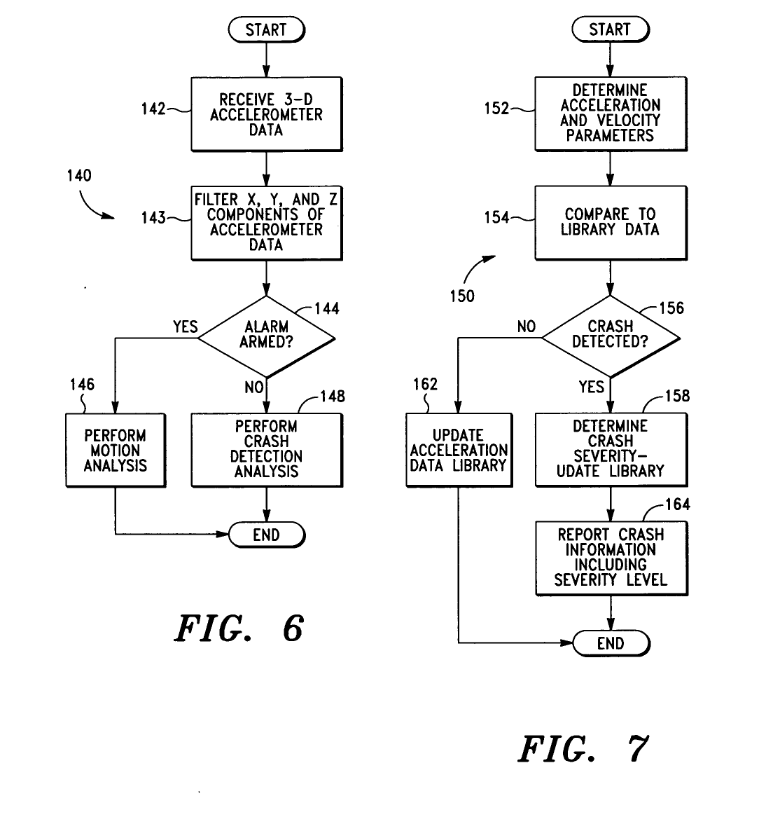

Referring now to FIG. 6, there is shown an illustration of an ATS algorithm 140 for initial acceleration processing, in accordance with one embodiment of the present invention. As shown in FIG. 6, when three dimensional accelerometer data is received, such as from the accelerometer shown in FIG. 4 or the accelerometer 190 shown in FIG. 9, the x, y,.and z components (or other three dimensional coordinates such as polar, spherical) of the accelerometer data (step 143) is filtered. In one embodiment, the system 140 low pass filters the components to remove small changes in acceleration due to variations in wind, passing traffic and other temporary external forces while the ATS 32 is armed, and variations road condition, contour and riding variations while the ATS 32 is disarmed. Depending on whether ATS 32 is armed (step 144), the ATS 32 may perform motion analysis (when armed) (such as process 100 shown in FIG. 5) (step 146) or crash detection analysis (when disarmed) (such as process 150 shown in FIG. 7) (step 140).

Referring now to FIG. 7, there is shown an illustration of an ATS algorithm (or process) 150 for crash detection, in accordance with one embodiment of the present invention. In the illustrated crash detection process 150, the acceleration and velocity parameters are determined from the filtered accelerometer components (step 152). In one embodiment, the following equations are employed to determine these parameters:

$$M = [ \begin{matrix}{{a}^{⋒}}_{x} & {\breve{a}}_{x} & {\overline{a}}_{x} \\ {{a}^{⋒}}_{y} & {\breve{a}}_{y} & {\overline{a}}_{y} \\ {{a}^{⋒}}_{z} & {\breve{a}}_{z} & {\overline{a}}_{z} \\ {{v}^{⋒}}_{a} & {\breve{v}}_{a} & {dv}_{a}\end{matrix} ]$$

$${\overline{a}}_{x} = \frac{1}{n} {\sum }_{i = 1}^{i = n} {a}_{{x}_{i}}$$

$${v}_{a} = \sqrt{{a}_{x}^{2} + {a}_{y}^{2} + {a}_{z}^{2}}$$

$${dv}_{a} = {{v}^{⋒}}_{a} - {\breve{v}}_{a}$$

n—Number of Samples in the Interval

In one embodiment, the determined acceleration and velocity parameters for each component x, y, and z are compared to library data to determine whether a crash has occurred and to determine the severity of the crash (steps 154, 156, 158). When a crash is detected, a crash report is generated and transmitted, including GPS information, unique identifier, and an indication of crash severity, including the actual acceleration and velocity parameters.

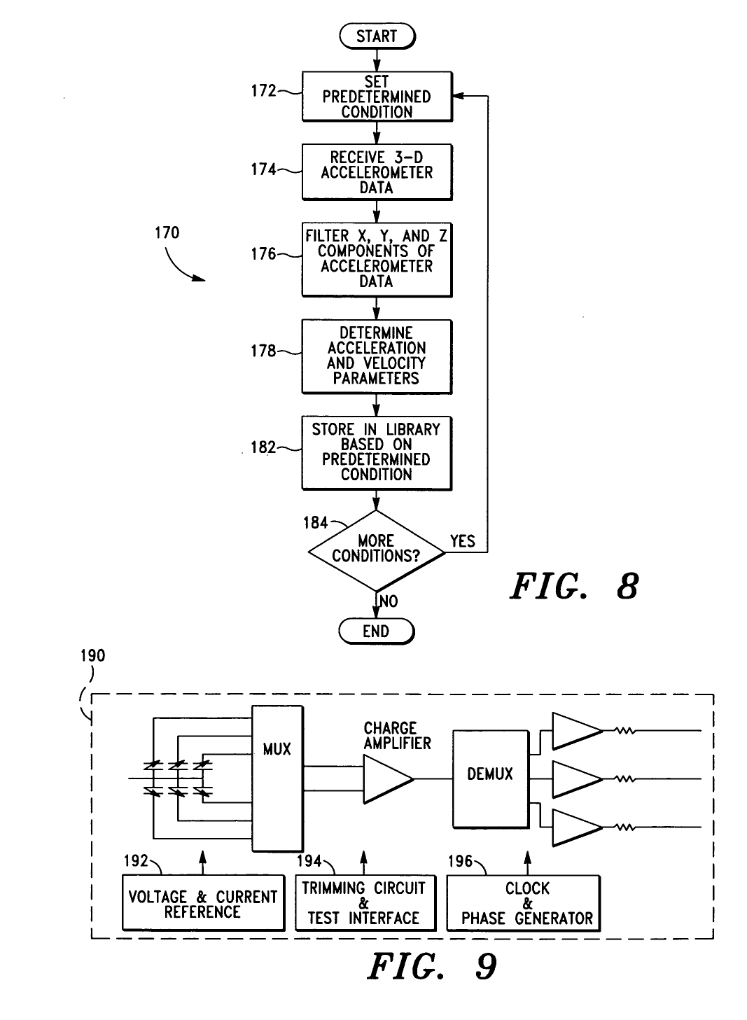

FIG. 8 illustrates an ATS algorithm 170 for populating a crash data library, in accordance with one embodiment of the present invention. According to the invention, the library of non-crash and crash values can be added into a library with an indication of what they represent (e.g., crash, non-crash, crash of a certain severity).

According to algorithm 170, a predetermined condition is set (step 172), the three dimensional accelerometer data for the set condition is then measured or received (step 174). The x, y, and z components (or other three dimensional coordinates such as polar, spherical) of the accelerometer data (step 176) is then filtered. In one embodiment, the components are subjected to low pass filtering to remove variations road condition, contour and riding variations.

As shown in FIG. 8, acceleration and velocity parameters are then determined from the filtered accelerometer components (step 178). According to the invention, the equations presented above can similarly be employed to determine these parameters.

The determined parameters are then stored in the library as appropriate (step 182). According to the invention, the noted process 170 can be repeated for additional predetermined conditions (step 184).

Referring now to FIG. 9, there is shown one embodiment of a three axis accelerometer 190 of the present invention. As illustrated in FIG. 9, the accelerometer 190 includes three primary sections: a voltage and current reference section 192, a trimming circuit and test interface section 194, and a clock and phase generator 196.

Referring to FIG. 10, there is shown an illustration of an ATS algorithm 200 for orienting a sensor, in accordance with one embodiment the present invention. In one embodiment, the unit or ATS 32 is set to teaching mode to orient the accelerometer 190 (step 202). When a user indicates that the unit is oriented (in the case of a motorcycle placed upright for example), the present accelerometer data is stored (it may be filtered and the parameters stored) in the library or other location to indicate the neutral location (step 206).

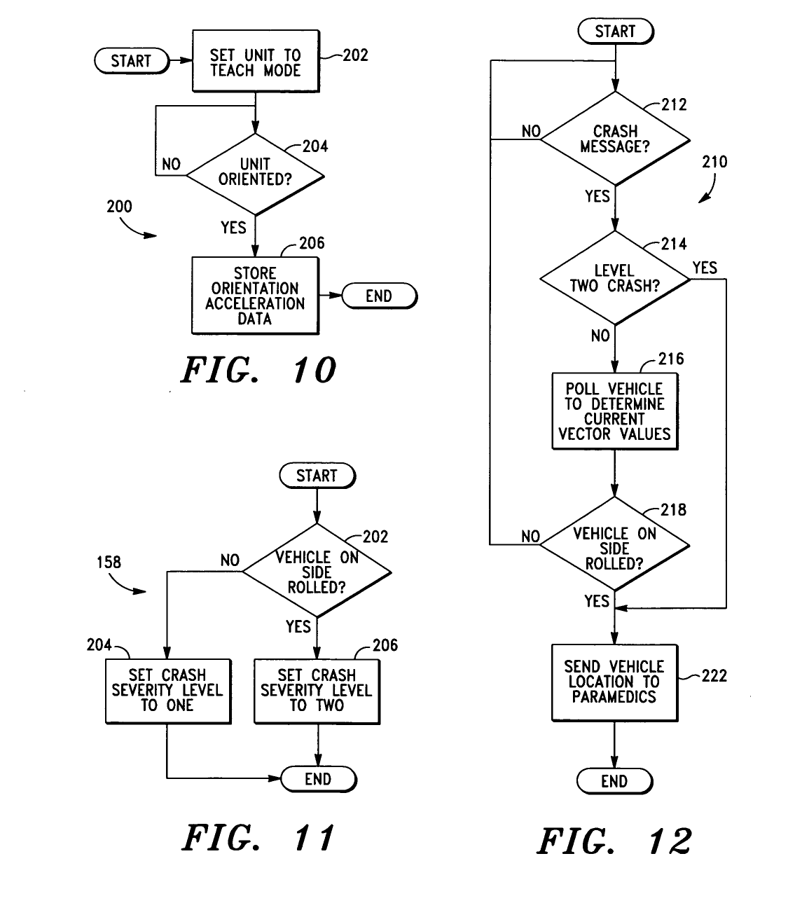

FIG. 11 illustrates an ATS algorithm 158 for determining crash severity in accordance with one embodiment of the present invention. In one embodiment, the acceleration parameters are initially evaluated to determine the vehicle orientation. In one embodiment, wherein the parameters indicate the vehicle is on its side or has rolled over (step 202), the crash level severity is set to level two (step 206). Otherwise the crash level severity is set to level one (step 204).

According to the invention, in the case of a two wheeled vehicle, the crash severity level is set to two when the vehicle is on its side. In one embodiment, when the Z acceleration value is about zero the vehicle is also deemed on its side.

FIG. 12 illustrates an ATS algorithm 210 for determining when to dispatch emergency services or personal to a crash site/vehicle location in accordance with one embodiment of the present invention. In accordance with the illustrated algorithm 210, when a call center receives a crash message from a vehicle (step 212), a request to dispatch emergency personal to the vehicle location (step 222) is issued when the crash severity, as indicated in the crash message, is level two (step 214). In one embodiment, the crash message includes a unique vehicle identifier and location data. The call center can then determine the vehicle's location and registered user based on the location data and vehicle identifier. The call center can also forward this information to emergency personal to aid their assistance to the vehicle passenger(s).

As shown in FIG. 12, in one embodiment, the vehicle is polled to determine its current acceleration values when a level one crash message is received. If the acceleration data or other information indicates that the vehicle is on its side or has rolled, emergency personal are requested to be dispatched to the vehicle's location. In one embodiment, the emergency personal are requested to be dispatched to the vehicle's location when the vehicle does not respond within a predetermined time interval.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein, but is to be accorded the widest scope consistent with the principles and novel features disclosed herein.

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

1-28. (canceled)

29. A system for detecting unsafe movement of a moveable object, the system comprising:
a central monitoring center, said center being capable of communicating messages on a first network; and
an anti-theft and crash detection apparatus, said apparatus: including a processor, a GPS receiver coupled to said processor, said GPS receiver being capable of receiving GPS signals from one or more satellites, a modem coupled to said processor, said modem being capable of communicating messages on a second network and a movement sensor, said movement sensor being capable of generating a movement signal when said sensor is moved in at least one direction, wherein said processor is capable of determining a location signal based a signal received from the GPS receiver, comparing said movement signal value to a library of movement signal values, sending an unsafe movement message to said central monitoring center when a movement signal value is greater than a corresponding movement value in said library of movement signal values.

30. The system of claim 29, wherein said movement sensor includes comprises a multiple axis accelerometer, said movement sensor being capable of generating a movement signal having value for each axis when said sensor is moved in at least one axis, and wherein said processor is capable of comparing the movement signal value for each axis to said library of movement values and sending an unsafe movement message to the central monitoring center when a movement signal value is greater than a corresponding movement value in said library of movement signal values based on a respective axis.

31. The system of claim 30, wherein said movement sensor comprises a three axes accelerometer.

32. The system of claim 31, wherein said processor is capable of determining said object orientation based on said movement sensor values.

33. (canceled)

34. The system of claim 33, wherein said apparatus includes a movement severity level identifier and wherein when said movement severity level identifier is set to a low level when the determined apparatus orientation is approximately horizontal and said movement severity level identifier is set to a high level when said determined apparatus orientation is approximately forty-five degrees or greater than horizontal, and wherein said central monitoring center requests emergency services to be dispatched to an apparatus indicated location when said movement severity level identifier is set to the high level.

35. A method for detecting unsafe movement of a moveable object, the method comprising the steps of:
a. providing a crash detection system, said crash detection system including a anti-theft and crash detection sub-system, GPS satellite network, at least one GPS receiver adapted to receive GPS signals, a movement sensor, a processing unit having a movement severity level identifier and library of movement signal values stored therein, a cellular network, monitoring center, dispatch station, and communication hub
b. generating a movement signal having a value associated therewith when said movement sensor is moved in at least one direction;
c. comparing said movement signal value to a corresponding movement signal value in said library of movement signal values;
d. receiving at least one GPS signal with said GPS receiver from one or more satellites;
e. determining a location signal based on said said received GPS signal;
f. generating an unauthorized movement message when said movement signal value is greater than a predetermined movement value, said message including a location signal and unique object identifier; and
g. transmitting an unsafe movement message to said monitoring center, said message including said location signal and unique object identifier.

36. The method of claim 35, wherein said movement sensor comprises a multiple axis accelerometer, and wherein step a. includes generating said movement signal having value for each axis when said sensor is moved in at least one axis, step b. includes comparing said movement signal value for each axis to said library of movement values, and step e. includes transmitting said unsafe movement message to a monitoring center when said movement signal value is greater than a predetermined corresponding movement value.

37. The method of claim 36, wherein said movement sensor comprises a three axes accelerometer.

38. The method of claim 37, wherein the method further comprises the step of determining orientation of the object based on said movement sensor values.

39. (canceled)

40. The method of claim 39, wherein said movement severity level identifier is set to a low level when said object orientation is approximately horizontal and the movement severity level identifier is set to a high level when said object orientation is approximately forty-five degrees or greater than horizontal, and wherein the method further comprises the step of said monitoring center requesting emergency services to be dispatched to the object indicated location when said movement severity level identifier is set to said high level.
